(19) United States
(12) Patent Application Publication
(10) Pub. No.: US 2006/0134363 A1
(43) Pub. Date: Jun. 22, 2006

(54) Printable substrate, processes and compositions for preparation thereof

(76) Inventors: Lawrence N. Nadeau, Orleans (CA); William Waddell, Coquitlam (CA); David K. Hood, Basking Ridge, NJ (US); Edward Johnson, St. Petersburg, FL (US); Jonathan P. Kitchin, Leander, TX (US); Manisha M. Sarkar, Austin, TX (US); Dwight L. Evans, Cedar Park, TX (US); Richard Gratton, Windsor (CA)

Correspondence Address: BACHMAN & LAPOINTE, P.C., 900 CHAPEL STREET, SUITE 1201, NEW HAVEN, CT, 06510, US

(21) Appl. No.: 11/280,845

(22) Filed: Nov. 15, 2005

Related U.S. Application Data
(60) Provisional application No. 60/627,159, filed on Nov. 15, 2004.

(51) Int. Cl. B32B 33/00

(52) U.S. Cl. 428/40.1

(57) ABSTRACT

The present invention relates to a composition composed of a crosslinkable resin containing lactam groups; a DMAPMA/HEMA copolymer copolymer; and a cellulose based water absorbent polymer. The invention also relates to a printable substrate composed of a substrate, optionally, a layer serving as a base layer; and at least one layer derived from a composition as defined in the present invention. Process for preparing such a printable substrate is also provided.

### CROSS REFERENCE TO RELATED APPLICATION

This application claims the benefit of U.S. provisional application No. 60/627,159 filed Nov. 15, 2004 which is incorporated herein by reference in its entirety.

### TECHNICAL FIELD

The present invention relates to the field of pulp and paper industry. In particular, this invention relates to a printable substrate, such as photographic paper. Compositions used for preparing the printable substrate as well as processes for preparing the compositions and the printable substrate are also disclosed.

### BACKGROUND OF THE INVENTION

Processes that are used nowadays for the preparation of photographic papers include the application techniques of cast coating, air knife coating or similar techniques. Such techniques usually require the application of about 3 to about 5 layers of ink receptive composition on the paper substrate which renders it tedious and costly. Another important drawback of these processes is that they cannot easily be applied on scale-up or large industrial tonnage paper machines, coaters, supercalenders and ancillary. Since the obtained cast-coated photographic papers are not typically calendared, they have low capacity for scale-up, and multiple layers are often used.

There is therefore a need for compositions to be used in the preparation of a printable substrate as well as processes for preparing such printable substrate.

### SUMMARY OF THE INVENTION

According to one aspect of the invention, there is provided a composition broadly comprising:
a crosslinkable resin broadly comprising lactam groups;
a DMAPMA/HEMA (Dimethylaminopropyl methacrylamide/Hydroxyethyl methacrylate) copolymer; and
a cellulose based water absorbent polymer.

According to another aspect of the invention, there is provided a printable substrate broadly comprising:
a substrate;
optionally, a layer serving as a base layer; and
at least one layer derived from a composition as defined in the present invention.

According to another aspect of the invention, there is provided a process for preparing a printable substrate broadly comprising the steps of:
a) providing a substrate;
b) optionally applying on the substrate a layer serving as a base layer; and
c) applying, on the substrate or the base layer, at least one layer of a composition as defined in the present invention.

### BRIEF DESCRIPTION OF THE DRAWINGS

The invention can be better described with reference to the following drawing, wherein

FIG. 1 is a schematic cross-sectional view of one embodiment of the present invention;

FIG. 2 is a view of a backside of another embodiment of the present invention; and

FIG. 3 is a is a schematic cross-sectional view of another embodiment of the present invention.

These figures are idealized, are not drawn to scale, and are intended for illustrative purposes only.

### DETAILED DESCRIPTION OF THE INVENTION

It has been found that the composition of the present invention is particularly useful for the preparation of printable substrates such as photographic papers. In particular, it has been found that this composition permits to prepare photographic papers which are durable and ink absorbent and which have a high level of gloss, and an ultra-smooth surface. This composition also permits to obtain a continuous ink receptive film which is suitable for photo glossy, satin or matte images on a paper substrate.

It has further been found that the previously mentioned printable substrates can be durable and ink absorbent. It has also been found that these printable substrates have a high level of gloss, and an ultra-smooth surface. Such printable substrates are simple and can be produced efficiently and at low costs since they may require the application of only one or two layers of the composition, according to the invention, on the substrate. The production of these printable substrates can also be easily scaled-up to large industrial tonnage paper machines, coaters, supercalenders and ancillary. It has also been found that these printable substrates permit to have short dry time on inkjet printers.

According to one embodiment of the invention, the substrate is selected from a base paper, canvas, copper, wood, textile, cotton, plastic, metal and aluminum.

In one embodiment, the substrate is selected from canvas, copper, wood, textile, cotton, polyester, plastic, metal and aluminum.

In one embodiment, the substrate is a base paper.

According to one embodiment of the invention, the printable substrate is photographic paper.

In accordance with a further embodiment of the invention, the printable substrate, such as a photographic paper, is for inkjet printers.

According to one embodiment of the invention, there is provided a photographic paper comprising:
a base paper; and
a layer derived from a composition as defined in the present invention.

In accordance with one embodiment of the invention there is provided a photographic paper comprising:
a base paper;
optionally a first layer preferably serving as a base layer; and
a second layer derived from a composition as defined in the present invention.

In accordance with one embodiment of the invention there is provided a photographic paper comprising:
a base paper;
optionally, a layer serving as a base layer; and
at least one layer derived from a composition as defined in the present invention.

The photographic paper of the above described embodiments can further comprise an adhesive, preferably a repositionable adhesive, disposed on the base paper, on the side opposite from the layer derived from a composition as defined in the present invention.

According to another aspect of the invention, there is provided a process for preparing a photographic paper comprising the steps of:
a) providing a base paper;
b) optionally applying on the base paper a first layer serving as a base layer;
c) applying, on the base paper or the base layer, at least one layer of a composition as defined in the present invention; and
d) optionally drying the base paper obtained in step (c), so as to obtain the desired photographic paper.

According to another embodiment of the invention, there is provided a process for preparing a photographic paper comprising the steps of:
a) providing a base paper;
b) optionally applying on the base paper a first layer serving as a base layer;
c) applying, on the base paper or the first layer, a composition as defined in the present invention so as to obtain a layer; and
d) calendering the paper obtained in step (c), so as to obtain the desired photographic paper.

According to another embodiment of the invention, there is provided a process for preparing a photographic paper comprising the steps of:
a) providing a base paper;
b) applying on the base paper a composition as defined in the present invention; and
c) calendering the paper obtained in step (b), so as to obtain the desired photographic paper.

According to another embodiment of the invention, there is provided a process for preparing a photographic paper comprising the steps of:
a) providing a base paper;
b) optionally applying on the base paper a first layer serving as a base layer;
c) preparing a first solution by admixing together a crosslinkable resin comprising lactam groups, a DMAPMA/HEMA copolymer, a cellulose based water absorbent polymer, and optionally preparing a second solution by admixing together water and at least one pigment;
d) mixing together the first solution, optionally the second solution, and optionally a buffer so as to maintain the obtained solution at a predetermined pH;
e) applying, on the base substrate or the first layer, the solution obtained in step (d) so as to obtain a layer; and
f) calendering the paper obtained in step (e), so as to obtain the desired photographic paper.

According to another embodiment of the invention, there is provided a process for preparing a photographic paper comprising the steps of:
a) providing a base substrate, and preferably a base paper;
b) optionally applying on the base paper a first layer serving as a base layer;
c) preparing a solution by admixing together a crosslinkable resin comprising lactam groups, a DMAPMA/HEMA copolymer, a cellulose based water absorbent polymer, optionally at least one pigment and optionally a buffer so as to maintain the obtained solution at a predetermined pH;
d) applying, on the base substrate or the first layer, the solution obtained in step (c) so as to obtain a layer; and
e) calendering the paper obtained in step (e), so as to obtain the desired photographic paper.

The photographic paper, made from the above described processes, can further include a step of applying an adhesive, preferably a repositionable adhesive, disposed on the base substrate or the base paper. Yet another step in these processes include applying a liner on the adhesive.

It has been found that the processes of the present invention can be carried out at large and industrial scale. Moreover, these processes are simple and can be carried out at low costs.

In one embodiment of the invention, there is provided a coating composition for the production of printable substrate for inkjet printers, said composition comprising:
a crosslinkable resin comprising lactam groups;
a DMAPMA/HEMA (Dimethylaminopropyl Methacrylamide/Hydroxyethyl Methacrylate) copolymer; and
a cellulose based water absorbent polymer.

In the composition of the present invention, the crosslinkable resin can comprise tertiary amino groups and/or hydroxyl groups. Preferably, the crosslinkable resin is a vinyllactam/dimethylaminopropylmethacrylamide/hydroxyethyl methacrylate terpolymer. The vinyllactam can be a vinylcaprolactam. A particularly preferred example of such a crosslinkable resin is the resin VIVIPRINT™ 200 manufactured by International Specialty Products (ISP).

The crosslinkable resin can have a molecular weight of about 500 000 to about 1 500 000 and preferably of about 500 000 to about 1 000 000.

The crosslinkable resin can be present in an amount of about 1 to about 99 weight %, preferably of about 40 to about 80 weight % or in an amount of about 60 to 90%, and more preferably of about 50 to about 75 weight %.

In the composition of the present invention, the DMAPMA/HEMA can have a molecular weight of about 250 000 to about 400 000. The DMAPMA/HEMA copolymer can be present in an amount of about 1 to about 99 weight %, preferably in an amount of about 1.5 to about 30.0 weight % and more preferably in an amount of about 2 to about 15 weight % or in an amount of about 5 to about 20 weight %. A particularly preferred example of such a DMAPMA/HEMA copolymer is VIVIPRINT™ 300 manufactured by International Specialty Products (ISP).

In the composition of the present invention, the cellulose based water absorbent polymer can be hydroxylpropylmethyl cellulose. The cellulose based water absorbent polymer is preferably 7.5% solids dispersion in water of Methocel™ F40, commercially available from Dow Chemicals Co., Midland, Mich. The cellulose based water absorbent polymer can be present in an amount of about 1 to about 99 weight %, preferably of about 5 to about 30 weight %, preferably in an amount of about 10 to about 20 weight %, and more preferably of about 10 to about 15 weight %.

The composition can comprise a solvent selected from the group consisting of methanol, ethanol, propanol, butanol, water, toluene, ethyl acetate, isopropyl acetate, chlorethene and mixtures thereof.

The composition can also comprise an organic pigment and/or an inorganic pigment. The organic pigment preferably comprises hollow or solid sphere plastic pigments. The organic pigment can comprise a polyvinylpolypyrrolidone (PVP) polymer. Alternatively, the organic pigment can comprise a 1-ethenyl-2-pyrrolidinone homopolymer, or a carboxylated styrene/acrylate polymer. A particularly preferred organic pigment is sold under the name VIVIPRINT™ PS-10 and is manufactured by International Specialty Products (ISP). Other particularly preferred organic pigments are sold under the name HS 3000NA™ and is manufactured by The Dow Chemical Company or Styronal ND811™ sold by BASF. The inorganic pigment comprises calcium carbonate, silica, aluminum based products (such as aluminum tri-hydrates (ATH) as manufactured by Alcoa, Alcan or Martinsworks) or clay based products (such as delaminated, calcined and/or easy glossing clays both from Georgia or Brazil—as produced by companies such as Imerys). A particularly preferred inorganic pigment is sold under the name MICRONA™ 7 and is manufactured by Columbia River Carbonates (CRC). The calcium carbonate can have a particle size of about 3 to about 12 microns, and preferably of about 7 microns. The silica can have a particle size of about 0.2 to about 5 microns, and preferably of about 1 to about 2 microns. The organic pigment can be present in an amount of about 0.1 to about 5 weight % and the inorganic pigment can be present in an amount of about 0.1 to about 10 weight %.

The composition of the present invention can also comprise a buffer. The buffer can comprise ammonium hydroxide, sodium hydroxide or ammonia containing crosslinkers. The buffer can be present in an amount of about 0.1 to about 5 weight %.

The composition of the present invention can also comprise a cross-linking agent (or crosslinker). The cross-linking agent can be a polyfunctional aziridine resin, an epoxy based agent, glyoxal, AZC (ammonium zirconium carbonates), or melamine formaldehydes. Particularly preferred cross-linking agents are CX-100™ manufactured by NeoResins Inc. and XAMA™ 7 manufactured by Bayer. The cross-linking agent can be present in an amount of about 0.1 to about 10 weight %.

The composition of the present invention can also comprise an optical brightener. The optical brightener can comprise derivatives of distyryl biphenyl compounds. The optical brightener preferably comprises 2,2′([1,1′-biphenyl]-4-4′diyldi-2,1-ethenediyl)bisbenzenesulfonic acid disodium salt. A particularly preferred optical brightener is sold by the company Ciba Speciality Chemicals under the name UVITEX NFW LIQUID™ Alternatively, the optical brightener can be a fluorescent whitening agent and preferably a tetra substituted or a hexa substituted fluorescent whitening agent. The optical brightener can be present in an amount of about 0.1 to about 20.0 weight %.

In the printable substrate of the invention, when they comprise a base layer, such a layer can comprise calcium carbonate, fine clays or delaminated clays. The base layer can comprise a binder selected from the group consisting of styrene butadiene rubber, styrene acrylates, polyvinyl alcohols, starches and their mixtures thereof. The base layer can be present on at least one side of the base paper and preferably on both side of the paper. The base layer is preferably present in an amount, on a dry basis, of about 10 to about 30 g/m², and more preferably in an amount of about 17 to about 22 g/m². In cases where the substrate is a base paper, the base paper can comprise virgin pulps of FSC grade.

In the printable substrate of the invention, the layer derived from the composition as defined in the present invention can be obtained by applying the composition to the substrate (such as a base paper) or the base layer and allowing the composition to dry.

When applied to a base paper the layer derived from the composition is dried, preferably, the substrate resulting from applying the composition of the present invention is calendared so as to obtain a gloss of at least 80% for 75 degrees according to TAPPI standard method, and more preferably of at least 90% for 75 degrees according to TAPPI standard method. The layer derived from the composition can be present in an amount, on a dry basis, of about 2 to 15 g/m², and preferably in an amount of about 4 to 10 g/m². The photographic papers can have a brightness of at least 80% and preferably of at least 90% according to TAPPI standard method. The photographic papers can have a dry time of less than 6 minutes, and preferably instantaneous to about 5 minutes using an inkjet printer suitable for producing photo-realistic images.

According to another embodiment of the invention there is provided a photographic paper comprising a coating having a layer derived from a composition as defined in the present invention. Preferably this coating further includes a base layer disposed between the paper and the layer derived form the composition.

The step comprising the application of a base layer can be carried out on a mill coater and only one side of the base paper is coated with the composition. Alternatively, this step can be carried out on a mill coater and both sides of the base paper are coated with the composition. The base layer can comprise calcium carbonate, fine clays or delaminated clays. The base layer can comprise a binder selected from the group consisting of styrene butadiene rubber, styrene acrylates, polyvinyl alcohols, starches and their mixtures thereof. The base layer coating can be present on at least one side of the base paper and preferably on both sides of the paper. The base layer coating is preferably present in an amount, on a dry basis, of about 10 to about 30 g/m², and more preferably in an amount of about 17 to about 22 g/m².

The step wherein the composition of the invention is applied can be carried out on a toll coater or a mill coater.

The step wherein the composition of the invention is dried can be conducted in a variety of methods. Among drying techniques that can be used is calendering. The calendering step can be carried out on a supercalender. Alternatively, it can be carried out using a steel on steel technique or a soft nip technique.

These processes according to the invention can also comprise the step of sheeting the photographic paper on a toll converter.

In the process of the present invention using two different solutions as described herein before at paragraph [0022], the predetermined pH is preferably of about from about 6 to about 9, preferably from about 7 to about 8 or from 7.0 to about 8.0. The second solution can be prepared by admixing together water and at least one pigment in a hi-shear mixer so that the pigment is allowed to swell. Step (d) is preferably carried out by mixing together the first solution, the second solution, a buffer and a cross-linking agent.

The processes of the present invention are particularly useful for preparing photographic papers. In one embodiment, the photographic paper made from the process can further comprise an adhesive, preferably a repositionable adhesive. Such an embodiment is further described below in detail.

The process may alternatively comprise the steps of providing a base paper, optionally applying a starch treatment, optionally applying a base coating on one or two sides of said paper, applying a composition according to the present invention, drying said composition (for example by calendering) and optionally sheeting or otherwise processing the so-obtained photographic paper.

In the processes of the present invention, the step of applying a composition of the present invention may be repeated one or more times to achieve the desired properties. Alternatively, the steps of applying a composition of the present invention and drying said composition (for example by calendering) may be repeated one or more times.

In the processes of the present invention, the step of applying a composition according to the present invention may be carried out on one or two sides of said paper. Preferably, it is carried out on one side.

The virgin pulp for the relatively heavy basis weight base paper can be a blend of hardwoods to ensure favorable formation. The grade is preferably “FSC” quality (Forest Stewardship Council) such that there is a chain of custody for the pulp from the forest to the finished sheet of paper. The quality attributes that can be important for the base paper include; low/no dirt, good dimensional stability (no curl issues), adequate sizing levels, and uniformity of the sheet in terms of basis weight, caliper and moisture. The starch treatment can include the use of a surface starch in water together with an optical brightening agent. The surface treatment at the paper machine can be a preliminary step to coating the sheet with a pigmentized coating. This treatment prepares the surface in terms of low debris levels and optical properties.

In the processes of the present invention applied to a base paper, the base paper can comprise virgin pulps (including FSC grade). The base paper can be submitted to a starch treatment before applying to the base paper a base layer or a layer derived from the composition of the invention. Such a treatment can be carried out by using a starch in water, preferably surface starch in water, together with an optical brightening agent which is preferably selected among the agents previously mentioned.

Coating done at the mill supplies a uniform surface that yields the properties desired for a Photographic (or Photo Gloss) sheet once the top coat step is accomplished. It has been found that the surface integrity and optical properties of the coating layer of the base coating layer play an important role in determining the final surface integrity and optical properties of the finished sheet. In one embodiment, the base coating is preferably consisting of calcium carbonate pigment (with no clays or other pigments). This allows for a relatively low cost and high brightness base coated sheet to be prepared prior to top coating.

All the technical considerations of the photographic paper are selected so as to eventually be applied to a large tonnage industrial paper machines, coaters, supercalenders and ancillary equipment.

The top coating is preferably prepared using the composition of the present invention so that, once calendared, it yields a high level of gloss and ultra-smooth surface. The surface, even after calendering, can allow inkjet inks to dry at an acceptable rate to form a photo-realistic image.

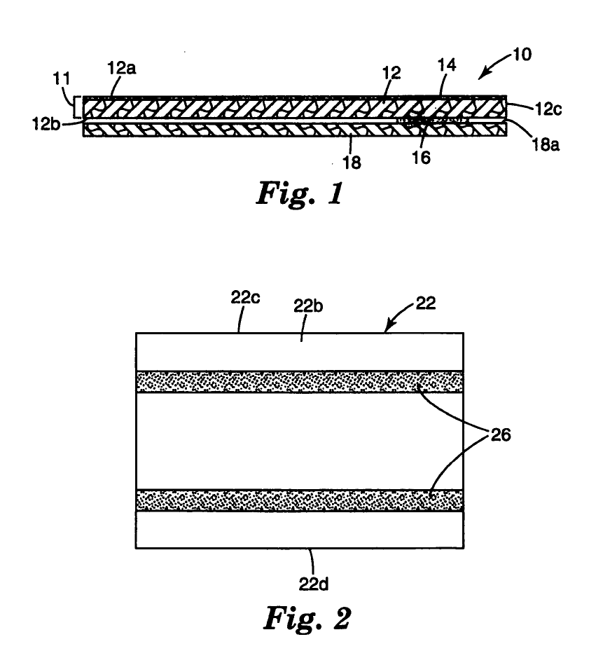

FIG. 1 shows a cross-sectional view of photographic paper 10. The photographic paper includes printable substrate 11 having base paper 12 and at least one layer 14 derived from the composition of the present invention. The base paper has opposing first surface 12a and second surface 12b. Optionally, a layer serving as a base layer (not shown) is disposed on at least one of the first and second surface. The layer 14 is disposed on and covers substantially the entire first surface of the base paper. Repositionable adhesive 16 is disposed on the second surface of the base paper and can but does not have to cover the entire surface area of the second surface. Liner 18 can, but does not have to be, the same size as the base paper. The liner is disposed on the adhesive and covers the second surface of the base paper. If desired, the liner can include a release coating disposed on major surface 18a so that the release coating is in direct contact with the repositionable adhesive. If desired, the opposing surface of surface 18a may be printed with indicia. While the repositionable adhesive can be placed anywhere on the second side of the base paper, in one embodiment, the adhesive is in the form of at least one stripe that is offset from and substantially parallel to edge 12c. In another embodiment, repositionable adhesive is disposed on the base paper such that the leading edge of the photographic paper, as it enters a printer having a primary feed wheel, is adhesively attached to the liner at the point the primary feed wheel contacts the sheet.

FIG. 2 is a view of the backside of the photographic paper showing second surface 22b of base paper 22, the base paper having two opposing substantially parallel edges 22c and 22d. Offset from the edges are two substantially parallel repositionable adhesive stripes 26. Other stripe configurations and different number of stripes can be used. For example, in an 8½ by 11 inch format, the photographic paper typically includes more than two stripes, usually four to five stripes, of adhesives. The adhesive can also be disposed immediately next to the edge, if desired. Instead of using stripes of adhesive, other patterns can be used, such as islands of adhesives. In non-stripe form, the adhesive can be disposed on the second surface. Such a construction allows for easy removal of the liner before attaching to a surface upon which the photo will be displayed and easy removal of the photographic paper after it has been applied to the display surface. The amount of surface area of the second surface that needs to be covered with the adhesive depends upon, among other factors, the size of the photographic paper, the repositionable adhesive used, and the intended display mode and location of the photographic paper.

Various repositionable adhesives can be used in the present invention. Suitable repositionable adhesives are disclosed in U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delagado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,237 (Cooprider et al.); U.S. RE 37,563 (Cooprider et al.); and U.S. Pat. No. 5,756,625 (Crandall et al.) and U.S. Pat. No. 5,824,748 (Kesti et al.). The repositionable adhesive can be solvent based, water based, or can be a solventless, hot melt adhesive.

The liner can be any paper or plastic sheet that bonds to the repositionable adhesive securely during storage and while passing through the feed mechanism of a printer. The liner releases cleanly and easily from the repositionable adhesive after printing the photo paper. The liner may be treated with a release coating to achieve the desired release performance. Suitable coatings include those that based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 gram/ft² (0.54 gram/m²) to 0.1 gram/ft² (1.1 gram/m²). Suitable silicone-based release liners are commercially available from Loparex, Inc., Willowbrook, Ill.

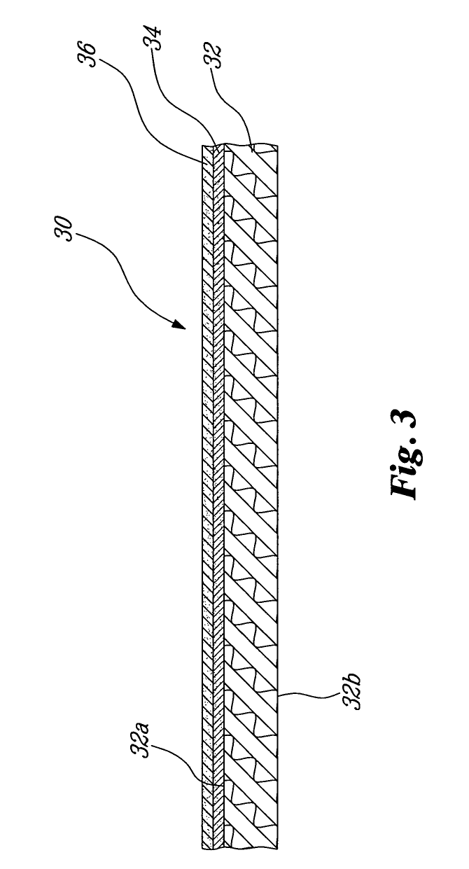

Referring to FIG. 3, a cross-sectional view of a photographic paper 30 according to one embodiment of the present invention is shown. The photographic paper includes base paper 32, base layer 34 and at least one layer 36 derived from the composition of the present invention. The base paper has first surface 32a and second surface 32b. The base layer is disposed on and covers substantially the entire first surface of the base paper. The layer 36 is disposed on and covers substantially the base layer 34.

Further features and advantages of the invention will become more readily apparent from the following description of preferred embodiments as illustrated by way of examples.

The following non-limiting examples further illustrate the invention.

### EXAMPLE 1

The major steps in manufacturing the photographic paper of the present invention were as follows:
a. providing a base paper (prior to surface starch treatment) at the paper machine in the mill.
b. applying a starch treatment at the paper machine in the mill.
c. applying a base coating (2 sides) at the mill coater in the mill.
d. applying a top coating that is a composition according to the present invention (1 side) at a toll coater or mill coater.
e. calendering at the supercalender in the mill.
f. sheeting at a toll converter at a sheeting facility.

### EXAMPLE 2

A composition was prepared using the following listed compounds: (weights “as is” are recorded for laboratory sized batches). The same ratio and sequence can be applied to industrial scale-up conditions.

A first solution was made from the first three (3) components that were made into a homogenized slurry using a hi-shear mixing technique.

| | |
|---|---|
| 1. water | 10 g |
| 2. calcium carbonate | 0.5 g |
| 3. PS-10 | 0.2 g |

The PS-10 was mixed for a period of 15 minutes to allow the polymer to swell so as to achieve its performance in the top coating.

A second solution was made from components 4 to 7 below. Then the first and second solutions were mixed together.

| | |
|---|---|
| 4. 7.5% solids dispersion in water of Methocel ™ F40 | 43.7 g |
| 5. Uvitex | 1.1 g |
| 6. Viviprint 200 | 53.1 g |
| 7. Viviprint 300 | 10 g |

It has been observed that alternatively to such a method of preparing a four components mixture and a three components mixture and then mixing these to mixtures together, it is also possible to simply add sequentially ingredients 1 to 7.

The photographic paper made using a C2S coated substrate (a standard coated two side commercial product), top-coated using a slot die coater for surface uniformity and super-calendared to achieve gloss has the approximate properties:
Grammage—250 gsm
Thichkness—8.4 mil
Brightness—95%
Sheet Gloss—95%
Print Gloss—85%
Dry Time—<5 minutes on all inkjet printers, all inks

### EXAMPLE 3

A composition similar to that in example 2 was prepared with the sequential addition of the following components:

| | | |
|---|---|---|
| Ammonium Hydroxide | 1 | g (approximate) |
| Neocryl CX-100 | 0.18 | g |

### EXAMPLE 4

In a manner similar to that described in examples 1 and 2, the following composition was prepared:

| | | |
|---|---|---|
| 1. 7.5% solids dispersion in water of | 437 | g |
| Methocel ™ F40 | | |
| 2. ISP Viviprint 200 | 531 | g |
| 3. Ciba Uvitex NFW | 10.6 | g |
| 4. Ammonium Hydroxyde | 2 | g (approximate) |
| 5. NeoResins CX100 | 0.31 | g |

| | |
|---|---|
| 6. Water | as req'd |

### EXAMPLE 5

In a manner similar to that described in examples 1 and 2, the following composition was prepared:

| | |
|---|---|
| 1. 7.5% solids dispersion in water of Methocel ™ F40 | 437 g |
| 2. ISP Viviprint 200 | 531 g |
| 3. Ciba Uvitex NFW | 10.6 g |
| 4. Ammonium Hydroxyde | 7.0 g |
| 5. NeoResins CX100 | 2.7 g |
| 6. Water | as req'd |

### EXAMPLE 6

In a manner similar to that described in examples 1 and 2, the following composition was prepared:

| | | |
|---|---|---|
| 1. | 7.5% solids dispersion in water of Methocel ™ F40 | 437 g |
| 2. | ISP Viviprint 200 | 531 g |
| 3. | Ciba Uvitex NFW | 11 g |
| 4. | Ammonium Hydroxyde | 10 g |
| 5. | Viviprint 300 | 100 g |
| 6. | GCC Microna 7 | 3.5 g |
| 7. | Viviprint PS10 | 3.5 g |
| 8. | Surfactant 10G | 10 g |
| 9. | NeoResins CX100 | 1.8 g |
| 10. | Water | as req'd |

### EXAMPLE 7

In a manner similar to that described in examples 1 and 2, the following composition was prepared:

| | |
|---|---|
| 1. GCC Microna 7 | 6.5 g |
| 2. Viviprint PS10 | 0.5 g |
| 3. Water | as req'd |

Components 1 to 3 were mixed for 15 minutes, then was added components 4 to 7:

| | |
|---|---|
| 4. 7.5% solids dispersion in water of Methocel ™ F40 | 437 g |
| 5. ISP Viviprint 200 | 531 g |
| 6. Ciba Uvitex NFW | 11 g |
| 7. Viviprint 300 | 100 g |

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A composition comprising:
a crosslinkable resin comprising lactam groups;
a DMAPMA/HEMA copolymer; and
a cellulose based water absorbent polymer.

2. The composition of claim 1, wherein said crosslinkable resin comprises tertiary amino groups and hydroxyl groups;

3. The composition of claim 1, wherein said crosslinkable resin is a vinyllactam/dimethylaminopropylmethacrylamide/hydroxyethyl methacrylate terpolymer.

4. The composition of claim 3, wherein said vinyllactam is vinylcaprolactam.

5. The composition of claim 1, wherein said DMAPMA/HEMA copolymer is present in an amount of about 1.5 to about 30.0 weight %.

6. The composition of claim 1, wherein said cellulose based water absorbent polymer is hydroxylpropylmethyl cellulose.

7. The composition of claim 1, wherein said cellulose based water absorbent polymer is present in an amount of about 5 to about 30 weight %.

8. The composition of claim 1, further comprising a solvent selected from the group consisting of methanol, ethanol, propanol, butanol, water, toluene, ethyl acetate, isopropyl acetate, chlorethene and mixtures thereof.

9. The composition of claim 1, further comprising at least one of an organic pigment and an inorganic pigment.

10. The composition of claim 1, further comprising a buffer.

11. The composition of claim 1, further comprising a cross-linking agent.

12. The composition of claim 1, further comprising an optical brightener.

13. A printable substrate comprising:
a substrate;
optionally, a layer serving as a base layer; and
at least one layer derived from a composition comprising:
a crosslinkable resin comprising lactam groups;
a DMAPMA/HEMA copolymer; and
a cellulose based water absorbent polymer.

14. The printable substrate of claim 13, wherein said base layer comprises calcium carbonate, fine clays or delaminated clays.

15. The printable substrate of claim 13, wherein said base layer comprises a binder selected from the group consisting of styrene butadiene rubber, styrene acrylates, polyvinyl alcohols, starches and their mixtures thereof.

16. The printable substrate of claim 13, wherein said crosslinkable resin comprises tertiary amino groups and hydroxyl groups;

17. The printable substrate of claim 13, wherein said crosslinkable resin is a vinyllactam/dimethylaminopropylmethacrylamide/hydroxyethyl methacrylate terpolymer.

18. The printable substrate of claim 13, wherein said vinyllactam is vinylcaprolactam.

19. The printable substrate of claim 13, wherein said cellulose based water absorbent polymer is hydroxylpropylmethyl cellulose.

20. A photographic paper comprising:
a base paper;
optionally a layer serving as a base layer; and
at least one layer derived from the composition comprising:
a crosslinkable resin comprising lactam groups;
a DMAPMA/HEMA copolymer; and
a cellulose based water absorbent polymer.

21. The photographic paper of claim 20, wherein said base layer comprises calcium carbonate, fine clays or delaminated clays.

22. The photographic paper as defined in claim 20, wherein said base layer comprises a binder selected from the group consisting of styrene butadiene rubber, styrene acrylates, polyvinyl alcohols and starches.

23. The photographic paper of claim 20 further comprising a repositionable adhesive disposed on the base paper on the opposing side of the at least one layer derived the from the composition.

24. The photographic paper of claim 23 further comprising a liner disposed on the repositionable adhesive.

25. The photographic paper of claim 24, wherein the liner is substantially the same size as the base paper and covers substantially the entire surface of the base paper.

26. The photographic paper of claim 23, wherein the repositionable adhesive is a microsphere adhesive.

27. The photographic paper of claim 26, wherein the repositionable adhesive comprises a polyacrylate derivative.

28. The photographic paper of claim 23, wherein the repositionable adhesive does not cover the entire surface of the base paper.

29. The photographic paper of claim 23, wherein the base paper has at least one edge, and the repositionable adhesive is in the form of at least one stripe offset from and substantially parallel to the at least one edge.

30. A process for preparing a printable substrate comprising the steps of:
a) providing a substrate,
b) optionally applying on the substrate a layer serving as a base layer,
c) applying, on the substrate or the base layer, at least one layer of a composition comprising:
a crosslinkable resin comprising lactam groups,
a DMAPMA/HEMA copolymer, and
a cellulose based water absorbent polymer.

31. The process of claim 30, wherein said substrate is treated with a composition comprising starch in water together with an optical brightening agent before step b).

32. The process as defined in claim 30 further comprising: d) drying the substrate obtained in step c).

33. The process of claim 32, wherein drying step d) is carried out by calendering.

34. The process of claim 30, further comprising sheeting the substrate on a toll converter.

35. A process for preparing a photographic paper comprising the steps of:
a) providing a base paper,
b) optionally applying on the base paper a layer serving as a base layer,
c) applying, on the base paper or the base layer, at least one layer of a composition comprising:
a crosslinkable resin comprising lactam groups,
a DMAPMA/HEMA copolymer, and
a cellulose based water absorbent polymer, and
d) calendering the base paper obtained in step (c).

36. The process of claim 35, further comprising applying a repositionable adhesive on the base paper obtained in step (d) on the opposing side of the composition obtained in step (c).

37. The process of claim 36, further comprising applying a liner to the repositionable adhesive.

38. The process of claim 35, wherein the repositionable adhesive is in the form of at least one stripe.

39. The process of claim 35, wherein the repositionable adhesive is a microsphere adhesive.

40. The process of claim 39, wherein the repositionable adhesive is a polyacrylate derivative.
